(19) United States
(12) Patent Application Publication
(10) Pub. No.: US 2011/0064994 A1
(43) Pub. Date: Mar. 17, 2011

(54) POWER SUPPLY ASSEMBLY

(75) Inventor: Wen-Hua Lin, Yilan County (TW)

(73) Assignees: NATIONAL ENERGY TECHNOLOGY CO., LTD., Tucheng City (TW); APOGEE POWER, INC., Campbell, CA (US)

(21) Appl. No.: 12/618,638

(22) Filed: Nov. 13, 2009

(30) Foreign Application Priority Data
Sep. 16, 2009 (TW) 98217111

(51) Int. Cl. H01M 4/02; H01M 2/00

(52) U.S. Cl. 429/163; 429/209

(57) ABSTRACT

A power supply assembly composed of an electric storage device and an electric energy conversion device. The electric storage device includes two electrodes. The electric energy conversion device includes at least one lithium iron phosphate battery. The at least one battery is electrically connected with the electrodes. In light of this, the power supply assembly can have denser electric storage and higher discharge rate, such that power supply assembly can discharge stably, have a longer working life, and have preferable discharging effect under the low-temperature environment.

### BACKGROUND OF THE INVENTION

1. Field of the Invention

The present invention relates generally to battery, and more particularly, to a power supply assembly.

2. Description of the Related Art

The electricity required for startup and ignition system of a car usually comes from the lead-acid battery. Because the lead-acid battery includes the advantages of low cost, less memorability, safety, and high working temperature, it is still very popular.

However, the lead-acid battery has a shorter cycle life to have a shorter working life. Besides, the lead-acid battery needs more time to recharge itself and has a higher self-discharge rate, i.e. the stored electric energy still easily consumes itself. If the battery is located under the low-temperature environment, its discharge will be subject to instability.

### SUMMARY OF THE INVENTION

The primary objective of the present invention is to provide a power supply assembly which can discharge stably, have a longer working life, and have preferable discharging effect under the low-temperature environment.

The foregoing objective of the present invention is attained by the power supply assembly composed of an electric storage device and an electric energy conversion device. The electric storage device includes two electrodes. The electric energy conversion device includes at least one lithium iron phosphate battery. The at least one battery is electrically connected with the electrodes. In light of this, the power supply assembly can have denser electric storage and higher discharge rate.

### BRIEF DESCRIPTION OF THE DRAWINGS

FIG. 1 is a block diagram of a preferred embodiment of the present invention.

FIG. 2 is a block diagram of the electric energy conversion device in accordance with the preferred embodiment of the present invention.

### DETAILED DESCRIPTION OF PREFERRED EMBODIMENTS

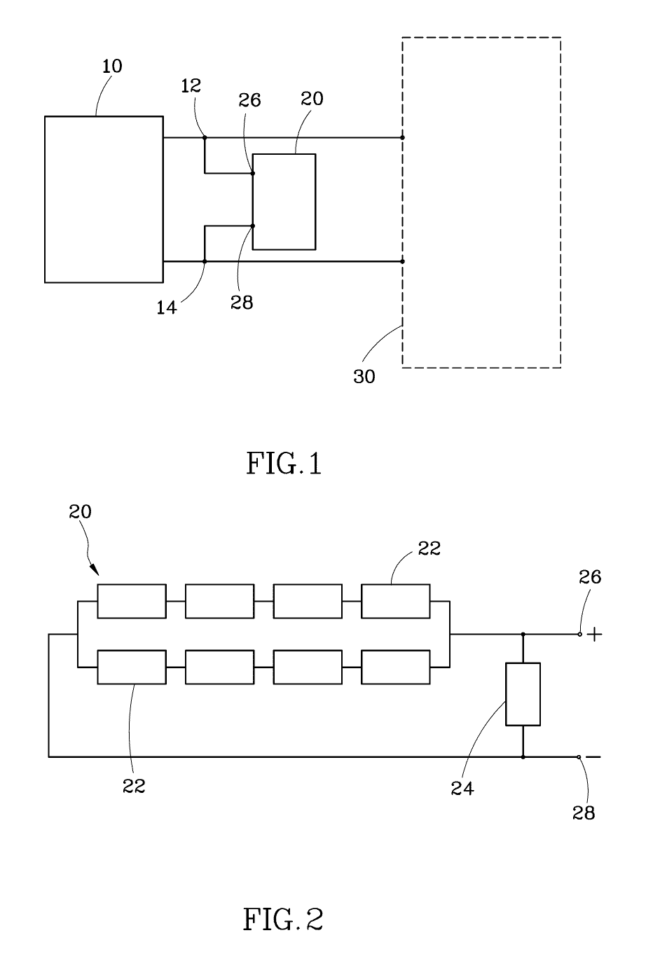

Referring to FIG. 1, a power supply assembly constructed according to a preferred embodiment of the present invention is composed of an electric storage device 10 and an electric energy conversion device 20. In this embodiment, the electric storage device 10 is a lead-acid battery having highly dense electric storage and includes a first electrode 12 and a second electrode 14.

Referring to FIG. 2, the electric energy conversion device 20 includes a plurality of lithium iron phosphate batteries 22, and a supercapacitor 24. Specifically, the batteries 22 are eight in number in this embodiment and can be electrically connected with one another by parallel connection of two pairs, each of which has four batteries 22 connected in series, and then connected with the supercapacitor 24 in parallel.

When the electric storage device 10 is mounted to a car, the first electrode 12 and the second electrode 14 are connected with an electric circuit 30 of the car. Electric energy stored in the electric storage device 10 can be supplied to an starting motor or an ignition coil of the car for operation. Because the battery 22 of the electric energy conversion device 20 is made of lithium iron phosphate to have high power and the supercapacitor 24 can be charged and discharged in no time, the car can be more efficiently ignited to cause less fuel consumption.

When the power generator of the car charges the electric storage device 10, the electric energy conversion device 20 is first quickly charged with electric energy and then the electric energy continues to be charged into the electric storage device 10. For this reason, even though the engine of the car runs in low rotation, the electric storage device 10 can be stably charged.

In addition, the electric energy conversion device 20 can be either combined with the electric storage device 10 or mounted to a housing and then additionally mounted to the electric storage device 10 for convenient application.

In conclusion, the power supply assembly can have denser electric storage and higher discharge rate, such that the present invention can discharge stably, have a longer working life, and have preferable discharging effect under the low-temperature environment.

Although the present invention has been described with respect to a specific preferred embodiment thereof, it is in no way limited to the specifics of the illustrated structures but changes and modifications may be made within the scope of the appended claims.

What is claimed is:

1. A power supply assembly comprising:
an electric storage device having two electrodes; and
an electric energy conversion device having at least one lithium iron phosphate battery, the battery being electrically connected with the electrodes.

2. The power supply assembly as defined in claim 1 further comprising a supercapacitor connected with the at least one battery in parallel.

3. The power supply assembly as defined in claim 1, wherein the electric storage device is a lead-acid battery.

4. The power supply assembly as defined in claim 1, wherein the electric energy conversion device is mounted to a housing mounted to the electric storage device.

5. The power supply assembly as defined in claim 1, wherein the electric storage device has denser electric storage than that of the at least one battery.
